(19) United States
(12) Patent Application Publication
(10) Pub. No.: US 2026/0009766 A1
(43) Pub. Date: Jan. 8, 2026

(54) ULTRASONIC APPARATUS AND MANUFACTURING METHOD THEREOF

(71) Applicant: SAMSUNG MEDISON CO., LTD., Hongcheon-Gun (KR)

(72) Inventors: Kuil JANG, Hongcheon-gun (KR); Eunhye SEO, Hongcheon-gun (KR); Sokjae SHIN, Hongcheon-gun (KR); Hyungwon YOON, Hongcheon-gun (KR)

(73) Assignee: SAMSUNG MEDISON CO., LTD., Hongcheon-Gun (KR)

(21) Appl. No.: 19/251,243

(22) Filed: Jun. 26, 2025

(30) Foreign Application Priority Data
Jul. 2, 2024 (KR) 10-2024-0087117
Feb. 21, 2025 (KR) 10-2025-0023240

(51) Int. Cl. G01N 29/22; G01N 29/06

(52) U.S. Cl. CPC G01N 29/226; G01N 29/0609; G01N 29/0672

(57) ABSTRACT

Disclosed is an ultrasonic apparatus including an electrical component, a housing configured to accommodate the electrical component and including openings provided to allow heat generated from the electrical component to be dissipated, a grille formed integrally with the openings to partition the openings, a filter configured to prevent foreign substances from being introduced into the housing through the openings, and a fastening member configured to fix the filter to the housing. The grille includes a hook configured to protrude toward the inside of the housing to guide a position of the filter.

### CROSS-REFERENCE TO RELATED APPLICATION(S)

This application is based on and claims priority under 35 U.S.C. § 119 to Korean Patent Application Nos. 10-2024-0087117 and 10-2025-0023240, filed on Jul. 2, 2024 and filed on Feb. 21, 2025, in the Korean Intellectual Property Office, the disclosure of which is incorporated by reference herein in its entirety.

### BACKGROUND

### 1. Field

The disclosure relates to an ultrasonic apparatus and a manufacturing method thereof.

### 2. Description of the Related Art

Recently, in a medical field, various medical imaging apparatuses have been widely used to image and obtain information about biological tissues of a human body for the purpose of early diagnosis of various diseases or surgery. Representative examples of such medical imaging apparatuses may include ultrasonic imaging apparatuses, computed tomography (CT) apparatuses, and magnetic resonance imaging (MRI) apparatuses.

An ultrasonic imaging apparatus is a device that emits an ultrasonic signal generated from a transducer of a probe to an object, and non-invasively obtains at least one image of a region inside the object (e.g., soft tissue or blood flow) by receiving information from the signal reflected from the object. An ultrasonic imaging apparatus may be used for medical purposes such as observing the inside of an object, detecting foreign substances, and measuring injury. Such an ultrasonic imaging apparatus is widely used together with other imaging diagnostic apparatuses because the ultrasonic imaging apparatus has higher stability than an imaging apparatus using an X-ray, may display images in real time, and is safe because there is no radiation exposure.

An ultrasonic apparatus includes an electrical component for controlling and operating the ultrasonic apparatus. An ultrasonic apparatus includes openings to communicate with the outside to allow heat generated from the electrical component to be dissipated, and may include a filter to prevent foreign substances from being introduced into the ultrasonic apparatus through the openings.

Conventionally, when the filter is assembled by heat fusion, investment costs such as jigs and equipment for heat fusion are excessive, and disassembly of the filter after fusion is difficult.

In addition, when the filter is assembled using a separate mold, investment in the mold is required to maintain a shape of the filter, and an additional process for assembling the filter is required.

### SUMMARY

It is an aspect of the disclosure to provide an ultrasonic apparatus having improved ease of assembly.

It is an aspect of the disclosure to provide a manufacturing method of an ultrasonic apparatus having improved case of assembly.

It is an aspect of the disclosure to provide an ultrasonic apparatus having a reduced production cost.

It is an aspect of the disclosure to provide an ultrasonic apparatus including a filter applicable to a curved housing.

Additional aspects of the disclosure will be set forth in part in the description which follows and, in part, will be obvious from the description, or may be learned by practice of the disclosure.

An aspect of the disclosure provides an ultrasonic apparatus including an electrical component, a housing configured to accommodate the electrical component and including openings provided to allow heat generated from the electrical component to be dissipated, a grille formed integrally with the openings to partition the openings, a filter configured to prevent foreign substances from being introduced into the housing through the openings, and a fastening member configured to fix the filter to the housing. The grille may include a hook configured to protrude toward the inside of the housing to guide a position of the filter.

Another aspect of the disclosure provides a manufacturing method of an ultrasonic apparatus including forming a hook protruding toward the inside of a housing on a grille configured to partition openings provided to allow heat inside the housing to be dissipated to the outside, forming a plurality of discharge holes on a filter configured to prevent foreign substances from being produced into the housing, coupling the filter to the hook, and fastening the filter to the housing.

### BRIEF DESCRIPTION OF THE DRAWINGS

These and/or other aspects of the disclosure will become apparent and more readily appreciated from the following description of the embodiments, taken in conjunction with the accompanying drawings of which:

FIGS. 1A and 2B are block diagrams illustrating components of an ultrasonic imaging system according to an embodiment of the disclosure;

FIGS. 2A, 2B, 2C, and 2D are views illustrating ultrasonic imaging apparatuses according to an embodiment of the disclosure;

FIG. 3 is a rear perspective view of an ultrasonic apparatus according to an embodiment of the disclosure;

FIG. 4 is an exploded view of the ultrasonic apparatus according to an embodiment of the disclosure;

FIGS. 5 and 6 each are views illustrating that a part is disassembled from the ultrasonic apparatus according to an embodiment of the disclosure;

FIG. 7 is a perspective view of a part of the ultrasonic apparatus according to an embodiment of the disclosure;

FIG. 8 illustrates a filter according to an embodiment of the disclosure;

FIG. 9 is a flowchart of a manufacturing method of the ultrasonic apparatus according to an embodiment of the disclosure;

FIG. 10 is a cross-sectional side view of a part of the ultrasonic apparatus according to an embodiment of the disclosure; and

FIG. 11 is a plan cross-sectional view of a part of the ultrasonic apparatus according to an embodiment of the disclosure.

### DETAILED DESCRIPTION

This disclosure will explain the principles and disclose embodiments of the disclosure to clarify the scope of the claims of the disclosure and enable those skilled in the art to which the embodiments of the disclosure belong to practice the embodiments. The embodiments of the disclosure may be implemented in various forms.

Throughout the specification, like reference numbers refer to like elements throughout this specification. This specification does not describe all components of the embodiments, and general contents in the technical field to which the disclosure belongs or overlapping contents between the embodiments will not be described. The “module” or “unit” used in the specification may be implemented as one or a combination of two or more of software, hardware, or firmware, and according to embodiments, a plurality of “module” or “unit” may be implemented as a single element, or a single “module” or “unit” may include a plurality of elements.

The singular form of a noun corresponding to an item may include a single item or a plurality of items, unless the relevant context clearly indicates otherwise.

In this disclosure, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

The terms such as “first,” “second,” “primary,” and “secondary” may simply be used to distinguish a given component from other corresponding components, and do not limit the corresponding components in any other respect (e.g., importance or order).

The terms “front surface,” “rear surface,” “upper surface,” “lower surface,” “side surface,” “left side,” “right side,” “upper portion,” “lower portion,” and the like used in the disclosure are defined with reference to the drawings, and the shape and position of each component are not limited by these terms.

The terms “comprises,” “has,” and the like are intended to indicate that there are features, numbers, steps, operations, components, parts, or combinations thereof described in the disclosure, and do not exclude the presence or addition of one or more other features, numbers, steps, operations, components, parts, or combinations thereof.

When any component is referred to as being “connected,” “coupled,” “supported,” or “in contact” with another component, this includes a case in which the components are indirectly connected, coupled, supported, or in contact with each other through a third component as well as directly connected, coupled, supported, or in contact with each other.

When any component is referred to as being located “on” or “over” another component, this includes not only a case in which any component is in contact with another component but also a case in which another component is present between the two components.

Hereinafter, an ultrasonic apparatus according to various embodiments will be described in detail with reference to the accompanying drawings. When described with reference to the accompanying drawings, similar reference numbers may be assigned to identical or corresponding components and redundant description thereof may be omitted.

In this disclosure, an image may include a medical image acquired by a medical imaging apparatus such as a magnetic resonance imaging (MRI) apparatus, a computed tomography (CT) apparatus, an ultrasonic imaging apparatus, and an X-ray imaging apparatus.

In this disclosure, an ‘object’, which is subject to photography, may include a person, animal, or part thereof. For example, the object may include a part of a human body (an organ, etc.) or a phantom.

In this disclosure, an ‘ultrasonic image’ refers to an image of an object that has been generated or processed based on an ultrasonic signal transmitted to and reflected from the object.

Hereinafter, embodiments of the disclosure will be described in detail with reference to the drawings.

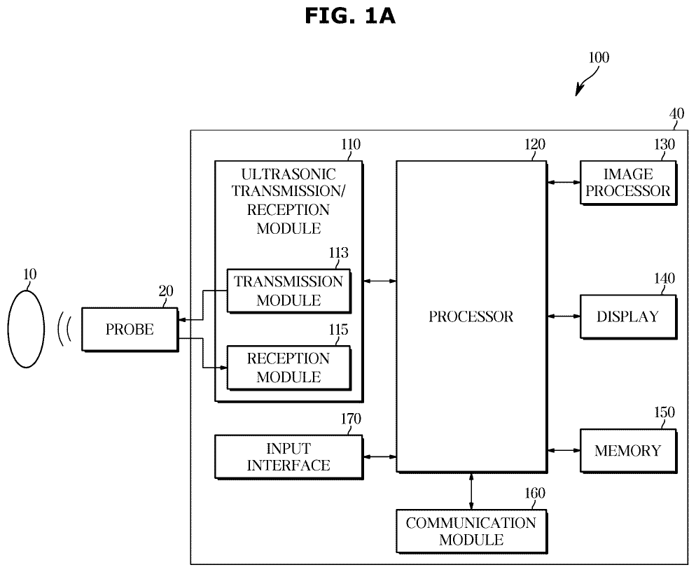

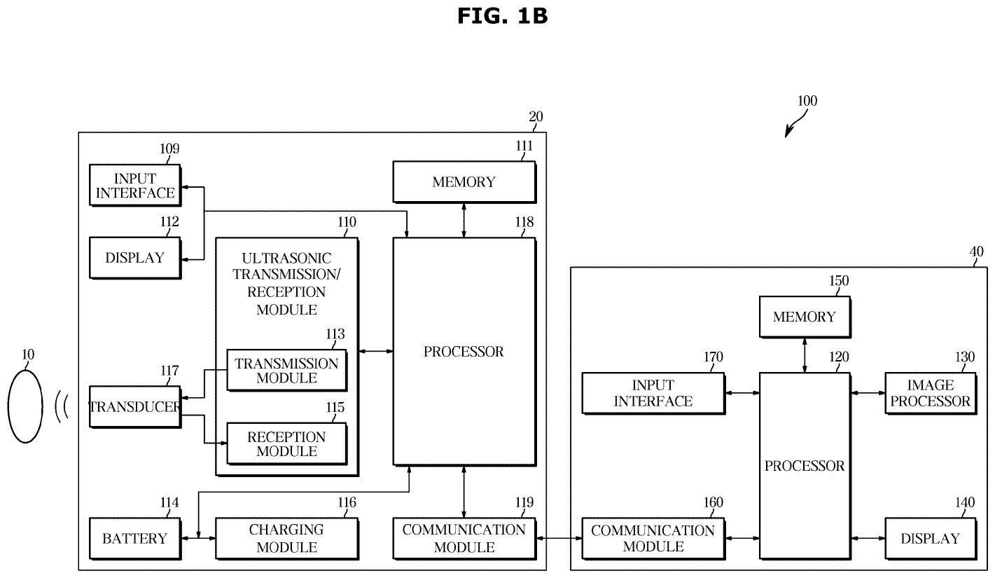

FIGS. 1A and 1B are block diagrams illustrating components of an ultrasonic imaging system according to an embodiment of the disclosure.

Referring to FIGS. 1A and 1B, an ultrasonic imaging system 100 may include a probe 20 and an ultrasonic imaging apparatus 40.

The ultrasonic imaging apparatus 40 may be implemented not only in a cart type but also in a portable type. A portable ultrasonic imaging apparatus may include, for example, a smart phone, a laptop computer, a personal digital assistant (PDA), a tablet PC, etc., which include a probe and an application, but is not limited thereto. The ultrasonic imaging apparatus 40 may also be implemented as an integrated probe.

The probe 20 may include a wired probe connected to the ultrasonic imaging apparatus 40 by wire to communicate with the ultrasonic imaging apparatus 40 by wire, a wireless probe wirelessly connected to the ultrasonic imaging apparatus 40 to communicate wirelessly with the ultrasonic imaging apparatus 40, and/or a hybrid probe connected to the ultrasonic imaging apparatus 40 by wire or wirelessly to communicate with the ultrasonic imaging apparatus 40 by wire or wirelessly.

According to various embodiments of the disclosure, as illustrated in FIG. 1A, the ultrasonic imaging apparatus 40 may include an ultrasonic transmission/reception module 110, and as illustrated in FIG. 1B, the probe 20 may include the ultrasonic transmission/reception module 110. According to various embodiments of the disclosure, both the ultrasonic imaging apparatus 40 and the probe 20 may also include the ultrasonic transmission/reception module 110.

According to various embodiments of the disclosure, the probe 20 may further include at least one or a combination of an image processor 130, a display 140, and an input interface 170. In the disclosure, descriptions of the ultrasonic transmission/reception module 110, the image processor 130, the display 140, and the input interface 170 included in the ultrasonic imaging apparatus 40 may also be applied to the ultrasonic transmission/reception module 110, the image processor 130, the display 140, and the input interface 170 included in the probe 20.

FIG. 1A is a block diagram illustrating components of the ultrasonic imaging system 100 in a case in which the probe 20 is a wired probe or a hybrid probe.

The probe 20 may include a plurality of transducers. The plurality of transducers may be arranged in a predetermined arrangement to be implemented as a transducer array. The transducer array may correspond to a one-dimensional (1D) array or a two-dimensional (2D) array. The plurality of transducers may transmit an ultrasonic signal to an object 10 in response to a transmission signal applied from a transmission module 113. The plurality of transducers may form a reception signal by receiving the ultrasonic signal (echo signal) reflected from the object 10. The probe 20 may be implemented as an integrated type with the ultrasonic imaging apparatus 40, or may be implemented as a separate type connected to the ultrasonic imaging apparatus 40 by wire. The ultrasonic imaging apparatus 40 may be connected to the one or more probes 20 depending on the implementation type.

In the case in which the probe 20 is a wired probe or a hybrid probe, the probe 20 may include a cable and a connector connectable to a connector of the ultrasonic imaging apparatus 40.

The probe 20 according to an embodiment of the disclosure may be implemented as a two-dimensional probe. In a case in which the probe 20 is implemented as a two-dimensional probe, the plurality of transducers included in the probe 20 may be arranged in two dimensions to form a two-dimensional transducer array.

For example, the two-dimensional transducer array may have a form in which a plurality of sub-arrays including the plurality of transducers arranged in a first direction is arranged in a second direction different from the first direction.

Also, in the case in which the probe 20 according to an embodiment of the disclosure is implemented as a two-dimensional probe, the ultrasonic transmission/reception module 110 may include at least one of an analog beamformer and a digital beamformer. Also, according to an embodiment of the disclosure, the two-dimensional probe may include at least one or a combination of the analog beamformer and the digital beamformer depending on the implementation type.

A processor 120 controls the transmission module 113 to form a transmission signal to be applied to each of transducers 117 in consideration of positions and focused points of the plurality of transducers included in the probe 20.

The processor 120 may control a reception module 115 to generate ultrasonic data by converting reception signals received from the probe 20 into analog to digital and summing up the digitally converted reception signals in consideration of the positions and focused points of the plurality of transducers.

In the case in which the probe 20 is implemented as a two-dimensional probe, the processor 120 may calculate a time delay value for digital beamforming by each sub-array for each of the plurality of sub-arrays included in the two-dimensional transducer array. The processor 120 may also calculate a time delay value for analog beamforming for each of the transducers included in one of the plurality of sub-arrays. The processor 120 may control the analog beamformer and the digital beamformer to form a transmission signal to be applied to each of the plurality of transducers depending on the time delay values for analog beamforming and the time delay values for digital beamforming. The processor 120 may also control the analog beamformer to sum up the signals received from the plurality of transducers by each sub-array depending on the time delay values for analog beamforming. The processor 120 may also control the ultrasonic transmission/reception module 110 to convert the summed signal by each sub-array into analog to digital. The processor 120 may also control the digital beamformer to generate ultrasonic data by summing up the digitally converted signals depending on the time delay values for digital beamforming.

The image processor 130 generates or processes an ultrasonic image using the generated ultrasonic data.

The display 140 may display the generated ultrasonic image and a variety of information processed in the ultrasonic imaging apparatus 40 or the probe 20. The probe 20 or the ultrasonic imaging apparatus 40 may include the one or more displays 140 depending on the implementation type. The display 140 may include a touch panel or a touch screen. The display 140 may also include a flexible display.

The processor 120 may control the overall operations of the ultrasonic imaging apparatus 40 and control operations of components of the ultrasonic imaging apparatus 40. The processor 120 may perform or control various operations or functions of the ultrasonic imaging apparatus 40 by executing programs or instructions stored in memory 150. The processor 120 may also control an operation of the ultrasonic imaging apparatus 40 by receiving a control signal from the input interface 170 or an external device.

The ultrasonic imaging apparatus 40 may include a communication module 160, and may be connected to and communicate with an external device (e.g., the probe 20, a server, a medical device, a portable device (a smart phone, tablet PC, wearable device, etc.)) through the communication module 160.

The communication module 160 may include one or more components enabling communication with the external device. The communication module 160 may include, for example, at least one of a short-range communication module, a wired communication module, and a wireless communication module.

The communication module 160 may receive a control signal and data from an external device. The processor 120 may control the operation of the ultrasonic imaging apparatus 40 according to the control signal received through the communication module 160. Also, the processor 120 may transmit a control signal to the external device through the communication module 160 to control the external device according to the transmitted control signal. The external device may operate according to the control signal received from the ultrasonic imaging apparatus 40 or may process the data received from the ultrasonic imaging apparatus 40.

A program or application related to the ultrasonic imaging apparatus 40 may be installed in the external device. The program or application installed in the external device may control the ultrasonic imaging apparatus 40 or operate according to the control signal or data received from the ultrasonic imaging apparatus 40.

The external device may receive or download the program or application related to the ultrasonic imaging apparatus 40 from the ultrasonic imaging apparatus 40, the probe 20, or a server, and install and execute the program or application in the external device. The ultrasonic imaging apparatus 40, the probe 20, or the server, which provides the program or application, may include a recording medium storing instructions, commands, installation files, executable files, or related data of the corresponding program or application. The external device may be sold with the program or application installed.

The memory 150 may store various data or programs for driving and controlling the ultrasonic imaging apparatus 40, inputted and outputted ultrasonic data, ultrasonic images, and the like.

The input interface 170 may receive user input for controlling the ultrasonic imaging apparatus 40. For example, the user input may include, but is not limited to, input of manipulating a button, a keypad, a mouse, a trackball, a jog switch, a knob, and the like, input of touching a touch pad or touch screen, voice input, motion input, biometric information input (e.g., iris recognition, fingerprint recognition, etc.), and the like.

FIG. 1B illustrates a control block diagram of the ultrasonic imaging system 100 in a case in which the probe 20 is a wireless probe or a hybrid probe.

According to various embodiments of the disclosure, the ultrasonic imaging apparatus 40 illustrated in FIG. 1B may be replaced with the ultrasonic imaging apparatus 40 described with reference to FIG. 1A.

According to various embodiments of the disclosure, the probe 20 described with reference to FIG. 1A may be replaced with the probe 20 to be described with reference to FIG. 1B.

The probe 20 may include a display 112, the transmission module 113, a battery 114, the transducer 117, a charging module 116, the reception module 115, an input interface 109, a processor 118, and a communication module 119. FIG. 1B illustrates that the probe 20 includes both the transmission module 113 and the reception module 115, but depending on the implementation type, the probe 20 may include only part of a configuration of the transmission module 113 and the reception module 115, and the part of the configuration of the transmission module 113 and the reception module 115 may also be included in the ultrasonic imaging apparatus 40. According to an embodiment of the disclosure, the probe 20 may further include the image processor 130.

The transducer 117 may include a plurality of transducers. The plurality of transducers may be arranged in a predetermined arrangement to be implemented as a transducer array. The transducer array may correspond to a one-dimensional (1D) array or a two-dimensional (2D) array. The plurality of transducers may transmit ultrasonic signals to the object 10 in response to transmission signals applied from the transmission module 113. The plurality of transducers may also receive ultrasonic signals reflected from the object 10 to form or generate electrical reception signals.

The charging module 116 may charge the battery 114. The charging module 116 may receive electric power from the outside. According to an embodiment of the disclosure, the charging module 116 may receive electric power wirelessly. According to an embodiment of the disclosure, the charging module 116 may also receive electric power by wire. The charging module 116 may transfer the received electric power to the battery 114.

The processor 118 controls the transmission module 113 to generate or form a transmission signal to be applied to each of the plurality of transducers in consideration of the positions and focused points of the plurality of transducers.

The processor 118 controls the reception module 115 to generate ultrasonic data by converting reception signals received from the transducer 117 into analog to digital and summing up the digitally converted reception signals in consideration of the positions and focused points of the plurality of transducers. According to an embodiment of the disclosure, in a case in which the probe 20 includes the image processor 130, the probe 20 may generate an ultrasonic image using the generated ultrasonic data.

In the case in which the probe 20 is implemented as a two-dimensional probe, the processor 118 may calculate the time delay value for digital beamforming by each sub-array for each of the plurality of sub-arrays included in the two-dimensional transducer array. The processor 118 may also calculate the time delay value for analog beamforming for each of the transducers included in one of the plurality of sub-arrays. The processor 118 may control the analog beamformer and the digital beamformer to form a transmission signal to be applied to each of the plurality of transducers depending on the time delay values for analog beamforming and the time delay values for digital beamforming. The processor 118 may also control the analog beamformer to sum up the signals received from the plurality of transducers by each sub-array depending on the time delay values for analog beamforming. The processor 118 may also control the ultrasonic transmission/reception module 110 to convert the summed signal by each sub-array into analog to digital. The processor 118 may also control the digital beamformer to generate ultrasonic data by summing up the digitally converted signals depending on the time delay values for digital beamforming.

The processor 118 may control the overall operations of the probe 20 and control operations of the components of the probe 20. The processor 118 may perform or control various operations or functions of the probe 20 by executing programs or instructions stored in memory 111. The processor 118 may also control an operation of the probe 20 by receiving a control signal from the input interface 109 of the probe 20 or an external device (e.g., the ultrasonic imaging apparatus 40). The processor 118 may also control the operation of the probe 20 by receiving a control signal from the input interface 109 or the external device. The input interface 109 may receive user input for controlling the probe 20. For example, the user input may include, but is not limited to, input of manipulating a button, a keypad, a mouse, a trackball, a jog switch, a knob, and the like, input of touching a touch pad or touch screen, voice input, motion input, biometric information input (e.g., iris recognition, fingerprint recognition, etc.), and the like.

The display 112 may display an ultrasonic image generated by the probe 20, an ultrasonic image generated by processing ultrasonic data generated in the probe 20, an ultrasonic image received from the ultrasonic imaging apparatus 40, or a variety of information processed in the ultrasonic imaging system 100. Also, the display 112 may further display state information of the probe 20. The state information of the probe 20 may include at least one of device information of the probe 20, battery state information of the probe 20, frequency band information of the probe 20, output information of the probe 20, information on whether the probe 20 is abnormal, setting information of the probe 20, and temperature information of the probe 20.

The probe 20 may include the one or more displays 112 depending on the implementation type. The display 112 may include a touch panel or a touch screen. The display 112 may also include a flexible display.

The communication module 119 may wirelessly transmit the generated ultrasonic data or ultrasonic images to the ultrasonic imaging apparatus 40 through a wireless network. The communication module 119 may also receive a control signal and data from the ultrasonic imaging apparatus 40.

The ultrasonic imaging apparatus 40 may receive the ultrasonic data or ultrasonic images from the probe 20.

According to an embodiment of the disclosure, in the case in which the probe 20 includes the image processor 130 capable of generating ultrasonic images using the ultrasonic data, the probe 20 may transmit the ultrasonic data or the ultrasonic images generated by the image processor 130 to the ultrasonic imaging apparatus 40.

According to an embodiment of the disclosure, in a case in which the probe 20 does not include the image processor 130 capable of generating ultrasonic images using the ultrasonic data, the probe 20 may transmit the ultrasonic data to the ultrasonic imaging apparatus 40. The ultrasonic data may include ultrasonic raw data, and the ultrasonic images may refer to ultrasonic image data.

The ultrasonic imaging apparatus 40 may include the processor 120, the image processor 130, the display 140, the memory 150, the communication module 160, and the input interface 170.

The image processor 130 generates or processes ultrasonic images using the ultrasonic data received from the probe 20.

The display 140 may display the ultrasonic images received from the probe 20, ultrasonic images generated by processing the ultrasonic data received from the probe 20, or a variety of information processed in the ultrasonic imaging system 100. The ultrasonic imaging apparatus 40 may include the one or more displays 140 depending on the implementation type. The display 140 may include a touch panel or a touch screen. The display 140 may also include a flexible display.

The processor 120 may control the overall operations of the ultrasonic imaging apparatus 40 and control the operations of the components of the ultrasonic imaging apparatus 40. The processor 120 may perform or control the various operations or functions of the ultrasonic imaging apparatus 40 by executing the programs or applications stored in the memory 150. The processor 120 may also control the operation of the ultrasonic imaging apparatus 40 by receiving a control signal from the input interface 170 or an external device.

The ultrasonic imaging apparatus 40 may include the communication module 160, and may be connected to and communicate with an external device (e.g., the probe 20, a server, a medical device, a portable device (a smart phone, tablet PC, wearable device, etc.)) through the communication module 160.

The communication module 160 may include one or more components that enable communication with the external device. The communication module 160 may include, for example, at least one of a short-range communication module, a wired communication module, and a wireless communication module.

The communication module 160 of the ultrasonic imaging apparatus 40 and the communication module 119 of the probe 20 may communicate using a network or a short-range wireless communication method. For example, the communication module 160 of the ultrasonic imaging apparatus 40 and the communication module 119 of the probe 20 may communicate using any one of wireless LAN, Wi-Fi, Bluetooth, ZigBee, Wi-Fi Direct (WFD), Infrared Data Association (IrDA), Bluetooth Low Energy (BLE), Near Field Communication (NFC), Wireless Broadband Internet (WiBro), World Interoperability for Microwave Access (WiMAX), Shared Wireless Access Protocol (SWAP), Wireless Gigabit Alliance (WiGig), RF communication, a wireless data communication method including 60 GHz millimeter wave (mm wave) short-range communication, etc.

To this end, the communication module 160 of the ultrasonic imaging apparatus 40 and the communication module 119 of the probe 20 may include at least one of a wireless LAN communication module, a Wi-Fi communication module, a Bluetooth communication module, a ZigBee communication module, a Wi-Fi Direct (WFD) communication module, an Infrared Data Association (IrDA) communication module, a Bluetooth Low Energy (BLE) communication module, a Near Field Communication (NFC) module, a Wireless Broadband Internet (WiBro) communication module, a World Interoperability for Microwave Access (WiMAX) communication module, a Shared Wireless Access Protocol (SWAP) communication module, a Wireless Gigabit Alliance (WiGig) communication module, a RF communication module, and a 60 GHz millimeter wave (mm wave) short-range communication module.

In an embodiment of the disclosure, the probe 20 may transmit device information (e.g., ID information) of the probe 20 to the ultrasonic imaging apparatus 40 using a first communication method (e.g., BLE) and be wirelessly paired with the ultrasonic imaging apparatus 40. The probe 20 may also transmit ultrasonic data and/or ultrasonic images to the paired ultrasonic imaging apparatus 40.

The device information of the probe 20 may include a variety of information related to a serial number, model name, or battery state of the probe 20.

The ultrasonic imaging apparatus 40 may receive the device information (e.g., ID information) of the probe 20 from the probe 20 using the first communication method (e.g., BLE) and be wirelessly paired with the probe 20. The ultrasonic imaging apparatus 40 may transmit an activation signal to the paired probe 20 and receive the ultrasonic data and/or ultrasonic images from the probe 20. In this case, the activation signal may include a signal for controlling the operation of the probe 20.

In an embodiment of the disclosure, the probe 20 may transmit the device information (e.g., ID information) of the probe 20 to the ultrasonic imaging apparatus 40 using the first communication method (e.g., BLE) and be wirelessly paired with the ultrasonic imaging apparatus 40. The probe 20 may also transmit the ultrasonic data and/or ultrasonic images to the ultrasonic imaging apparatus 40 paired by the first communication method using a second communication method (e.g., 60 GHz millimeter wave and Wi-Fi).

The ultrasonic imaging apparatus 40 may receive the device information (e.g., ID information) of the probe 20 from the probe 20 using the first communication method (e.g., BLE) and be wirelessly paired with the probe 20. The ultrasonic imaging apparatus 40 may also transmit the activation signal to the paired probe 20 and receive the ultrasonic data and/or ultrasonic images from the probe 20 using the second communication method (e.g., 60 GHz millimeter wave and Wi-Fi).

According to an embodiment of the disclosure, the first communication method used to pair the probe 20 and the ultrasonic imaging apparatus 40 with each other may have a frequency band lower than a frequency band of the second communication method used by the probe 20 to transmit the ultrasonic data and/or ultrasonic images to the ultrasonic imaging apparatus 40.

The display 140 of the ultrasonic imaging apparatus 40 may display UIs (user interfaces) indicating the device information of the probe 20. For example, the display 140 may display UIs, which indicate identification information of the wireless ultrasonic probe 20, a pairing method indicating a pairing method with the probe 20, a data communication state between the probe 20 and the ultrasonic imaging apparatus 40, a method of performing data communication with the ultrasonic imaging apparatus 40, the battery state of the probe 20, etc.

In a case in which the probe 20 includes the display 112, the display 112 of the probe 20 may display the UI indicating the device information of the probe 20. For example, the display 112 may display the UIs, which indicate the identification information of the wireless ultrasonic probe 20, the pairing method indicating the pairing method with the probe 20, the data communication state between the probe 20 and the ultrasonic imaging apparatus 40, the method of performing the data communication with the ultrasonic imaging apparatus 40, the battery state of the probe 20, etc.

The communication module 160 may receive a control signal or data from an external device. The processor 120 may control the operation of the ultrasonic imaging apparatus 40 according to the control signal received through the communication module 160.

Also, the processor 120 may transmit the control signal to the external device through the communication module 160 to control the external device according to the transmitted control signal. The external device may operate according to the control signal received from the ultrasonic imaging apparatus 40 or process the data received from the ultrasonic imaging apparatus 40.

The external device may receive or download the program or application related to the ultrasonic imaging apparatus 40 from the ultrasonic imaging apparatus 40, the probe 20, or the server, and install and execute the program or application in the external device. The ultrasonic imaging apparatus 40, the probe 20, or the server, which provides the program or application, may include a recording medium storing instructions, commands, installation files, executable files, or related data of the program or application. The external device may be sold with the program or application installed.

The memory 150 may store various data or programs for driving and controlling the ultrasonic imaging apparatus 40, inputted and outputted ultrasonic data, ultrasonic images, etc.

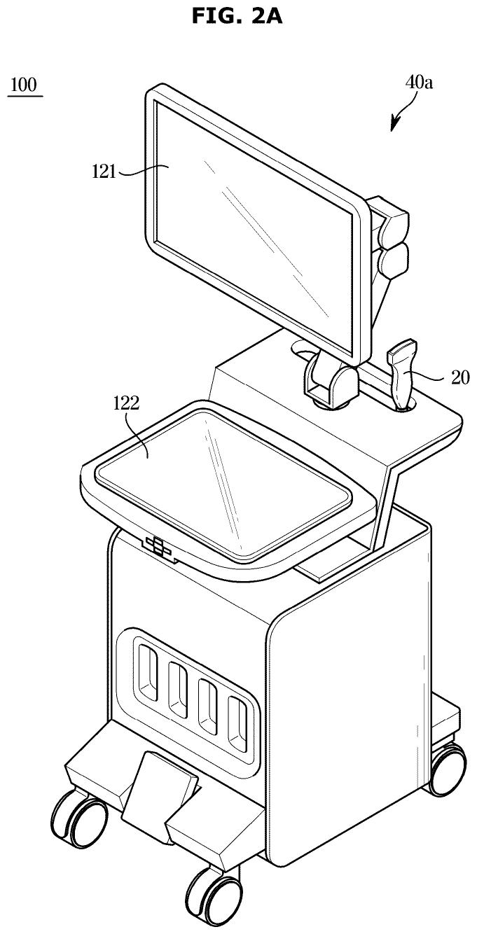

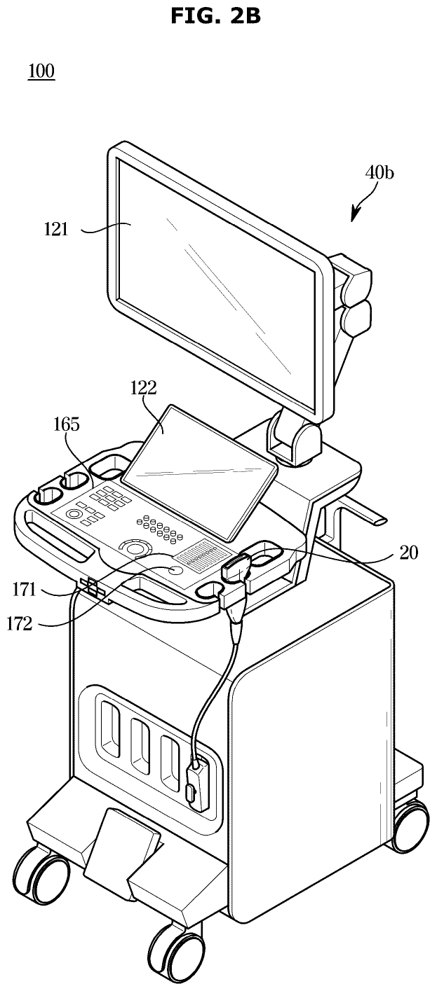

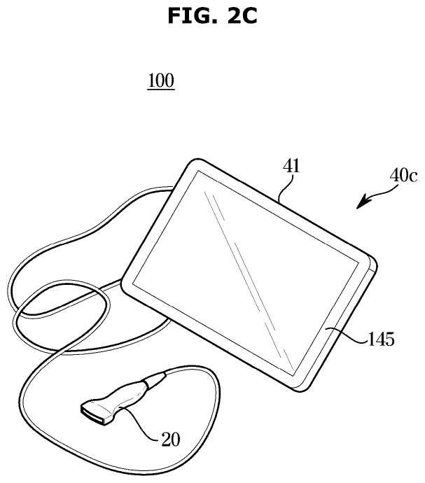

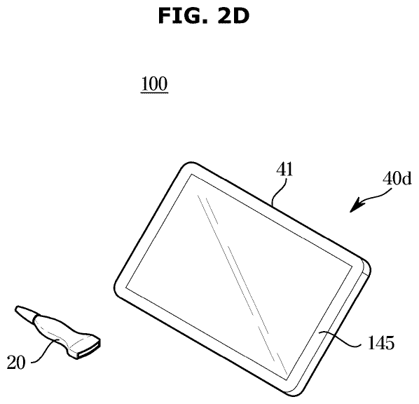

Examples of the ultrasonic imaging system 100 according to an embodiment of the disclosure will be described later with reference to FIGS. 2A, 2B, 2C, and 2D.

FIGS. 2A, 2B, 2C, and 2D are views illustrating ultrasonic imaging apparatuses according to an embodiment of the disclosure.

Referring to FIGS. 2A and 2B, ultrasonic imaging apparatuses 40a and 40b may include a main display 121 and a sub display 122. The main display 121 and the sub-display 122 may correspond to the display 140 in FIGS. 1A and 1B. At least one of the main display 121 and the sub display 122 may be implemented as a touch screen. At least one of the main display 121 and the sub display 122 may display an ultrasonic image or a variety of information processed in the ultrasonic imaging devices 40a and 40b. Also, at least one of the main display 121 and the sub display 122 may be implemented as a touch screen, and may receive input of data for controlling the ultrasonic imaging apparatuses 40a and 40b from a user by providing GUIs. For example, the main display 121 may display ultrasonic images, and the sub display 122 may display a control panel for controlling the display of the ultrasonic images in the form of GUIs. The sub display 122 may receive input of data for controlling the display of images through the control panel displayed in the form of GUIs. For example, a time gain compensation (TGC) button, a lateral gain compensation (LGC) button, a Freeze button, a trackball, a jog switch, a knob, and the like may be provided as GUIs on the sub display 122.

The ultrasonic imaging apparatuses 40a and 40b may control the display of ultrasonic images displayed on the main display 121 using the inputted control data. Also, the ultrasonic imaging apparatuses 40a and 40b may be connected to the probe 20 by wire or wirelessly to transmit and receive ultrasonic signals to and from the object 10.

Referring to FIG. 2B, the ultrasonic imaging apparatus 40b may further include a control panel 165 in addition to the main display 121 and the sub display 122. The control panel 165 may include a button, a trackball, a jog switch, a knob, and the like, and may receive input of data for controlling the ultrasonic imaging apparatus 40b from the user. For example, the control panel 165 may include a TGC button 171, a Freeze button 172, and the like. The TGC button 171 is a button for setting a TGC value by each of depths of ultrasonic images. The ultrasonic imaging apparatus 40b may keep a state in which a frame image at that point in time is displayed, capture the frame image at that point in time, or store the frame image at that point in time, when the Freeze button 172 input is detected while scanning an ultrasonic image.

The button, trackball, jog switch, knob, and the like included in the control panel 165 may be provided as GUIs on the main display 121 or the sub display 122. The ultrasonic imaging apparatuses 40a and 40b may be connected to the probe 20 to transmit and receive ultrasonic signals to and from the object 10.

The ultrasonic imaging apparatuses 40a and 40b may include various types of input/output interfaces such as speakers, LEDs, and vibration devices. For example, the ultrasonic imaging apparatuses 40a and 40b may output a variety of information in the form of graphics, sound, or vibration through the input/output interfaces. The ultrasonic imaging apparatuses 40a and 40b may also output various notifications or data through the input/output interfaces.

Referring to FIGS. 2C and 2D, ultrasonic imaging apparatuses 40c and 40d may be implemented in a portable type. The portable ultrasonic imaging apparatuses 40c and 40d may include, for example, smart phones, laptop computers, PDAs, or tablet PCs, which include probes and applications, but is not limited thereto.

The ultrasonic imaging apparatus 40c may include a main body 41. Referring to FIG. 2C, the probe 20 may be connected to one side of the main body 41 by wire. To this end, the main body 41 may include a connection terminal to and from which a cable connected to the probe 20 may be attached and detached. The probe 20 may include a cable including a connection terminal capable of being connected to the main body 41.

Referring to FIG. 2D, the probe 20 may be wirelessly connected to the ultrasonic imaging apparatus 40d. The main body 41 may include an input/output interface (e.g., a touch screen). Ultrasonic images, a variety of information processed in the ultrasonic imaging apparatus, or GUIs may be displayed on the input/output interface.

The ultrasonic imaging apparatus 40d and the probe 20 may establish communication or be paired using a short-range wireless communication. For example, the ultrasonic imaging apparatus 40d and the probe 20 may perform communication using Bluetooth, BLE, Wi-Fi, or Wi-Fi Direct.

The ultrasonic imaging apparatuses 40c and 40d may execute a program or application related to the probe 20 to control the probe 20 and output information related to the probe 20. The ultrasonic imaging apparatuses 40c and 40d may perform operations related to the probe 20 while communicating with a predetermined server. The probe 20 may be registered with the ultrasonic imaging apparatuses 40c and 40d or may be registered with the predetermined server. The ultrasonic imaging apparatuses 40c and 40d may communicate with the registered probe 20 and perform the operations related to the probe 20.

The ultrasonic imaging apparatuses 40c and 40d may also include various types of input/output interfaces such as speakers, LEDs, and vibration devices. For example, the ultrasonic imaging apparatuses 40c and 40d may output a variety of information in the form of graphics, sound, or vibration through the input/output interfaces. The ultrasonic imaging apparatuses 40c and 40d may also output various notifications or data through the input/output interfaces.

According to an embodiment of the disclosure, the ultrasonic imaging apparatus 40a, 40b, 40c, or 40d may process an ultrasonic image or obtain additional information from the ultrasonic image using an artificial intelligence (AI) model. According to an embodiment of the disclosure, the ultrasonic imaging apparatus 40a, 40b, 40c, or 40d may, using the AI model, perform image processing such as generating ultrasonic images, correcting ultrasonic images, improving image quality, encoding, or decoding. According to an embodiment of the disclosure, the ultrasonic imaging apparatus 40a, 40b, 40c, or 40d may also, using the AI model, perform processing of reference line definition, anatomical information obtainment, lesion information obtainment, surface extraction, boundary definition, length measurement, area measurement, volume measurement, or annotation creation, from ultrasonic images.

The AI model may be provided on the ultrasonic imaging apparatus 40a, 40b, 40c, or 40d, or may be provided on the server.

The AI model may be implemented using various artificial neural network models or deep neural network models. In addition, the AI model may be learned and created using various machine learning algorithms or deep learning algorithms. The AI model may be implemented using, for example, a model such as a convolutional neural network (CNN), a recurrent neural network (RNN), a generative adversarial network (GAN), or a long short-term memory (LSTM).

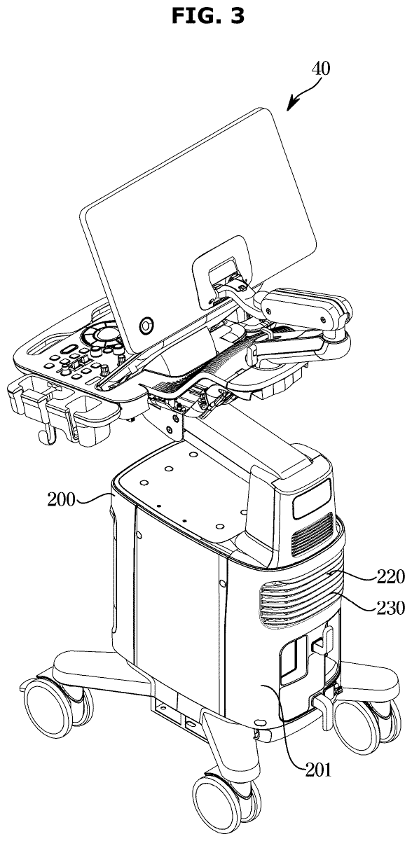

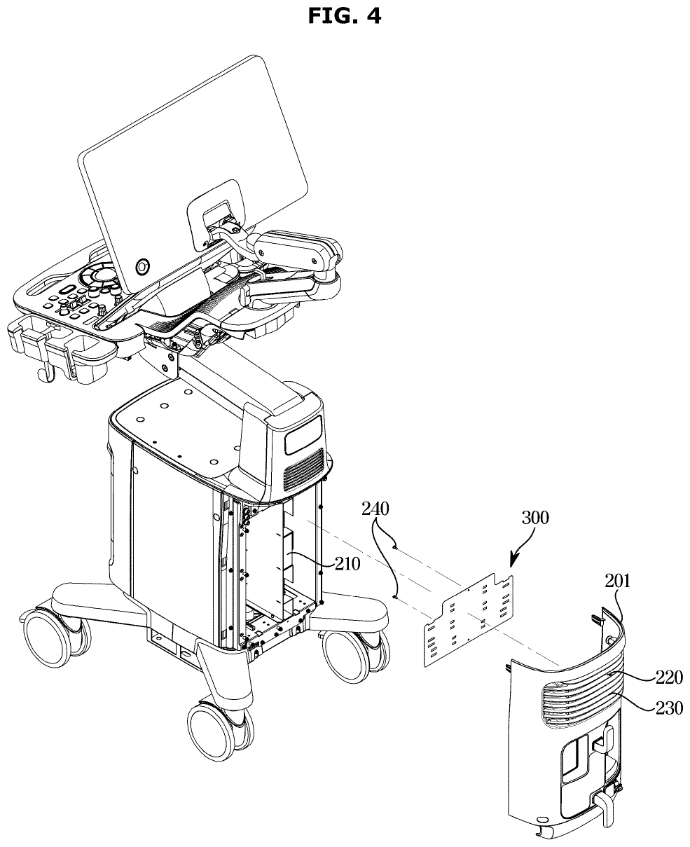

FIG. 3 is a rear perspective view of an ultrasonic apparatus according to an embodiment of the disclosure. FIG. 4 is an exploded view of the ultrasonic apparatus according to an embodiment of the disclosure.

Referring to FIGS. 3 and 4, the ultrasonic imaging apparatus 40 according to an embodiment of the disclosure may include a housing 200. The ultrasonic imaging apparatus 40 may also be referred to as the ultrasonic apparatus 40.

The housing 200 may form an outer appearance of the ultrasonic apparatus 40. The housing 200 may include a rear housing 201. The rear housing 201 may be separated from the ultrasonic apparatus 40.

The ultrasonic apparatus 40 may include an electrical component 210. The housing 200 may accommodate the electrical component 210. The electrical component 210 may include a heating portion (not shown).

The position and shape of the electrical component 210 according to an embodiment of the disclosure are not limited to those illustrated in the drawing. The electrical component 210 may be positioned anywhere inside the housing 200 and may have various shapes.

The housing 200 may include openings 220 provided to allow heat generated from the electrical component 210 to be dissipated to the outside. The openings 220 may be formed on the rear housing 201. The rear housing 201 may include the openings 220. However, the openings 220 are not limited thereto and may be disposed on a front surface or a side surface of the housing 200. Hereinafter, as an example, it will be described that the openings 220 are formed on the rear housing 201.

The ultrasonic apparatus 40 may include a filter 300. The filter 300 may be configured to cover the openings 220 to prevent foreign substances, etc., from being introduced into the housing 200 through the openings 220. The filter 300 may be disposed to correspond to the openings 220.

The filter 300 may be configured to cover the openings 220 inside the housing 200. The filter 300 may be disposed to cover inner sides of the openings 220.

The filter 300 may be fixed to the housing 200 by a fastening member 240. The filter 300 may be fixed to the rear housing 201 by the fastening member 240.

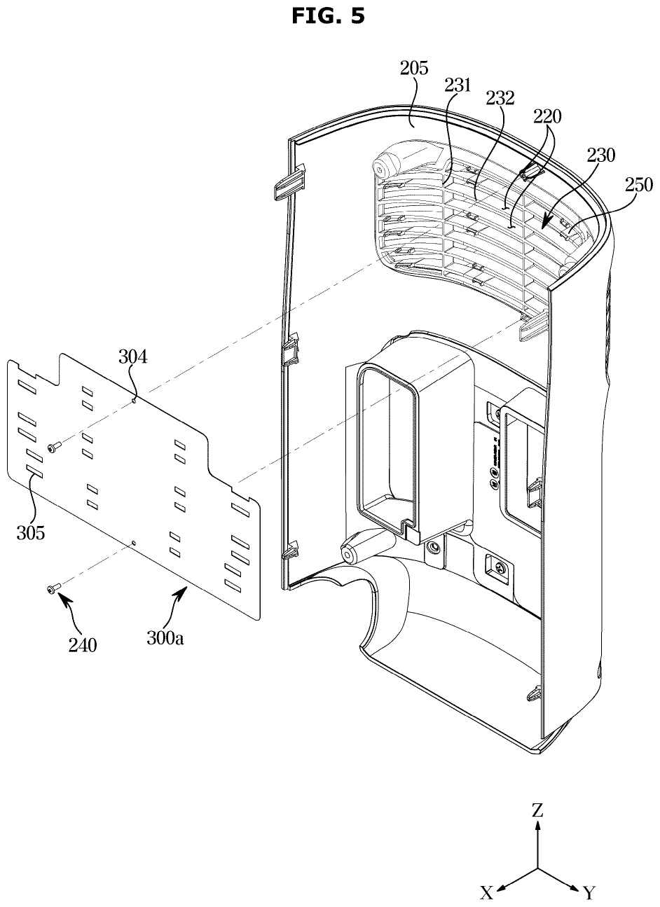

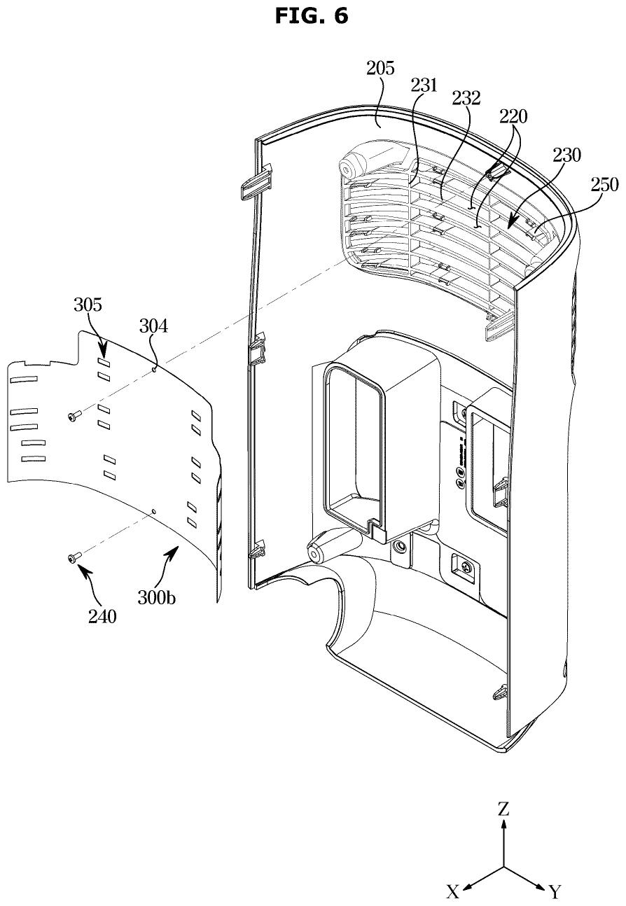

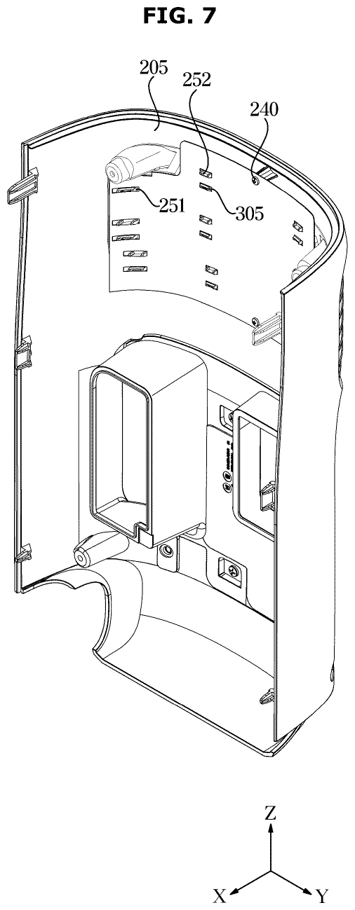

FIGS. 5 and 6 each are views illustrating that a part is disassembled from the ultrasonic apparatus according to an embodiment of the disclosure. FIG. 7 is a perspective view of a part of the ultrasonic apparatus according to an embodiment of the disclosure.

Referring to FIGS. 5 to 7, the ultrasonic apparatus 40 according to an embodiment of the disclosure may include a grille 230.

The grille 230 may be formed integrally with the openings 220. The grille 230 may partition the openings 220. The grille 230 may include a vertical grille 231 and/or a horizontal grille 232. The horizontal grille 232 may extend in a left-right direction (Y direction). The vertical grille 231 may extend in an up-down direction (Z direction).

The housing 200 may include a curved portion 205. The curved portion 205 may be formed in the rear housing 201. The openings 220 may be disposed in the curved portion 205. The horizontal grille 232 may extend in a curve to correspond to the curved portion 205.

The drawing illustrates that the grills 230 includes both the horizontal grills 232 and the vertical grills 231, but is not limited thereto, and the grills 230 may include only one of the horizontal grills 232 and the vertical grills 231.

The ultrasonic apparatus 40 may include a hook 250. The hook 250 may be formed in the grille 230. The hook 250 may have a shape of protruding from the grills 230 to the inside of the housing 200.

The hook 250 may guide the filter 300 into position. The hook 250 may fix the filter 300. The hook 250 may prevent the filter 300 from having a gap with the rear housing 201.

As described above, the filter 300 may be fixed to the rear housing 201 by the fastening member 240. The filter 300 may include a passing hole 304 formed to allow the fastening member 240 to pass therethrough.

The fastening member 240 may be a screw. However, the fastening member 240 is not limited thereto, and any fastening means fixing easily detachably the rear housing 201 and the filter 300 may be the fastening member 240.

A filter 300a may include a flexible material. A shape of the filter 300a before being fixed to the rear housing 201 may be a planar surface. The filter 300a may be bent into a curve corresponding to the rear housing 201 including the curved portion 205 by including a flexible material. That is, the shape of the filter 300a may be changed.

In contrast, a shape of a filter 300b before being fixed to the rear housing 201 may correspond to a shape of the rear housing 201. That is, the shape of the filter 300b may be not changed.

The filter 300 may include a coupling hole 305 formed to allow the hook 250 to pass therethrough. A plurality of the hooks 250 may be provided. A plurality of the coupling holes 305 may be provided to correspond with the hooks 250. A size of the coupling hole 305 may be equal to or larger than that of the hook 250.

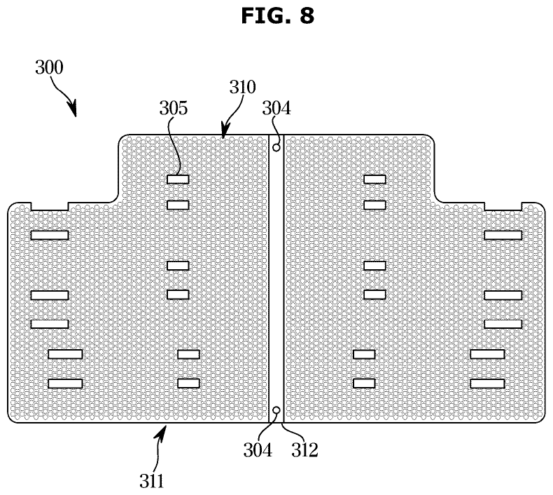

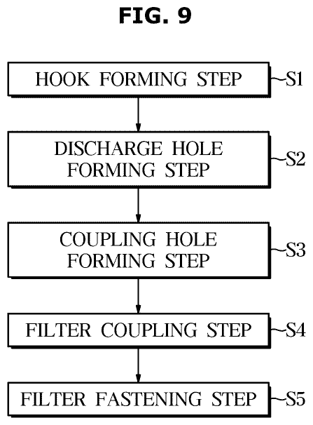

FIG. 8 illustrates a filter according to an embodiment of the disclosure. FIG. 9 is a flowchart of a manufacturing method of the ultrasonic apparatus according to an embodiment of the disclosure.

Referring to FIGS. 8 and 9, a plurality of discharge holes 310 may be formed on the filter 300 according to an embodiment of the disclosure.

Air inside the housing 200 may be discharged through the discharge holes 310 of the filter. A diameter of the discharge hole 310 may be 2 mm or more and 4 mm or less. Air inside the housing 200 may be discharged through the discharge holes 310, but foreign substances outside the housing 200 larger than a size of the discharge hole 310 may not be able to be introduced into the housing 200.

The drawing illustrates that a shape of the discharge hole 310 is circular, but it is not limited thereto, and may have any shape within the range of an area of the discharge hole 310 having the diameter of 2 mm or more and 4 mm or less.

The filter 300 may include the passing hole 304. A plurality of the passing holes 304 may be provided. A size of the passing hole 304 may be a size in which a portion of the fastening member 240 may pass therethrough.

The filter 300 may include a first portion 311 and a second portion 312. The discharge holes 310 may be formed on the first portion 311. The discharge holes 310 may not be formed on the second portion 312.

The second portion 312 may be disposed in a central portion of the filter 300. The passing hole 304 may be formed on the second portion 312. The second portion 312 may be disposed in the central portion of the filter 300. The filter 300 may be formed in a symmetrical structure left and right about the central portion.

A manufacturing method of the ultrasonic apparatus according to an embodiment of the disclosure may include a hook forming step S1, a discharge hole forming step S2, a filter coupling step S4, and a filter fastening step S5.

The hook forming step S1 may be a step of forming the hook 250 protruding toward the inside of the housing 200 on the grille 230. The hook forming step S1 may include forming a first hook 251 disposed to be spaced apart from a center of the grille 230. The hook forming step S1 may include forming a second hook 252 disposed to be closer to the center of the grille 230 than the first hook 251.

The discharge hole forming step S2 may be a step of forming the plurality of discharge holes 310 on the filter. The diameter of the discharge hole 310 may be 2 mm or more and 4 mm or less. The manufacturing method of the ultrasonic apparatus may include a step of manufacturing the filter 300 including a flexible material so as to cover inner sides of the openings 220.

The filter coupling step S4 may be a step of coupling the filter 300 to the rear housing 201. The manufacturing method of the ultrasonic apparatus may include a coupling hole forming step S3 of allowing the hook 250 to penetrate the filter 300 before the filter 300 is coupled to the rear housing 201. The hook 250 may penetrate the filter 300 in the filter coupling step S4.

The discharge hole forming step S2 may precede the coupling hole forming step S3, and the coupling hole forming step S3 may precede the discharge hole forming step S2.

The filter fastening step S5 may be a step of fastening the filter 300 to the rear housing 201 using the fastening member 240.

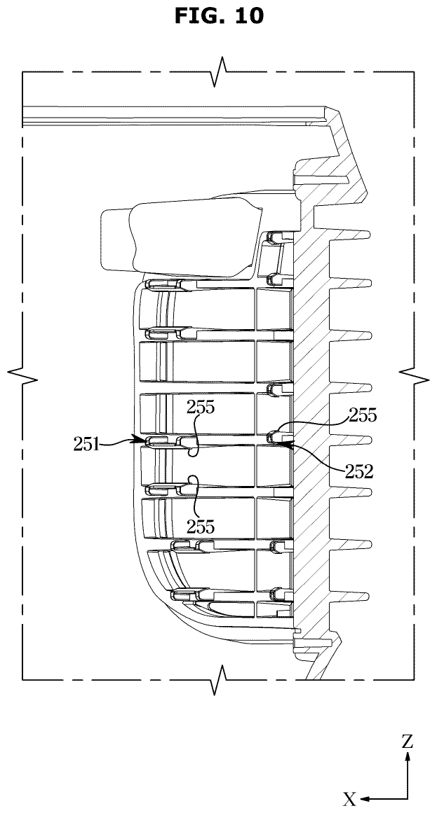

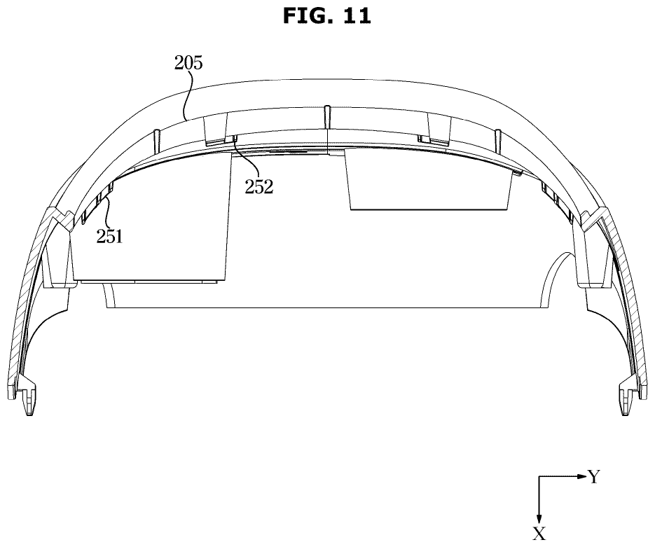

FIG. 10 is a cross-sectional side view of a part of the ultrasonic apparatus according to an embodiment of the disclosure. FIG. 11 is a plan cross-sectional view of a part of the ultrasonic apparatus according to an embodiment of the disclosure.

Referring to FIGS. 10 and 11, the hook 250 according to an embodiment of the disclosure may include the first hook 251 and the second hook 252.

The first hook 251 may be disposed to be spaced apart from the center of the grille 230. The second hook 252 may be disposed to be closer to the center of the grille 230 than the first hook 251.

The filter 300 may include an elastic material. The filter 300 may have a shape of a flat surface and a curved surface. When the filter 300 has a curved shape, stress may be generated such that the filter 300 is deformed into a flat shape by an elastic force. A direction in which the stress is generated and a direction in which the first hook 251 extends intersect, so that the first hook 251 may support the filter 300 of the curved shape.

When the filter 300 has a curved shape, a gap may be generated in the central portion of the filter 300 so that the filter 300 is deformed into a flat shape by the elastic force. The second hook 252 may be disposed to be closer to the center of the grille 230 than the first hook 251 to prevent the filter 300 from being deformed into a flat shape.

The hook 250 may include a rib 255. The rib 255 may protrude in a direction of intersecting the direction in which the hook 250 extends to prevent the filter 300 from being separated from the rear housing 201. The rib 255 may protrude upward or downward.

An ultrasonic apparatus according to an embodiment of the disclosure may include an electrical component, a housing configured to accommodate the electrical component and including openings provided to allow heat generated from the electrical component to be dissipated, a grille formed integrally with the openings to partition the openings, a filter configured to prevent foreign substances from being introduced into the housing through the openings, and a fastening member configured to fix the filter to the housing. The grille may include a hook configured to protrude toward the inside of the housing to guide a position of the filter.

The filter may be disposed inside the housing.

A plurality of discharge holes may be formed on the filter to allow air inside the housing to be discharged to the outside.

The filter may include a first portion in which the discharge holes are formed and a second portion in which the discharge holes are not formed.

The hook may be configured to penetrate the filter.

The filter may include a coupling hole formed such that the hook is coupled thereto.

The filter may include a passing hole formed to allow the fastening member to pass therethrough.

The passing hole may be formed in a central portion of the filter, and the filter may be formed in a symmetrical structure left and right about the central portion.

The housing may include a curved portion formed as a curved surface, and the openings may be disposed on the curved portion.

The filter may include a flexible material so as to cover inner sides of the openings.

A plurality of hooks may be provided, and the plurality of hooks may be arranged to be spaced apart from each other.

The hook may include a first hook disposed to be spaced apart from a center of the grille.

The hook may include a second hook disposed to be closer to the center of the grille than the first hook.

The hook may include a rib protruding upward or downward to prevent the filter from being separated.

A manufacturing method of an ultrasonic apparatus according to an embodiment of the disclosure may include forming a hook protruding toward the inside of a housing on a grille configured to partition openings provided to allow heat inside the housing to be dissipated to the outside, forming a plurality of discharge holes on a filter configured to prevent foreign substances from being produced into the housing, coupling the filter to the hook, and fastening the filter to the housing.

A diameter of the discharge hole may be 2 mm or more and 4 mm or less.

The manufacturing method may further include forming a coupling hole on the filter to couple the filter to the hook.

The housing may include a curved portion formed as a curved surface, and the openings may be disposed on the curved portion.

The manufacturing method may further include manufacturing the filter including a flexible material so as to cover inner sides of the openings.

The hook may include a first hook disposed to be spaced apart from a center of the grille, and a second hook disposed to be closer to the center of the grille than the first hook.

As is apparent from the above, according to the disclosure, the ease of assembly of an ultrasonic apparatus can be improved.

According to the disclose, manufacturing processes of the ultrasonic apparatus can be simplified by a manufacturing method of the ultrasonic apparatus that does not require separate components for fixing a filter to a housing.

According to the disclose, a manufacturing cost of the ultrasonic apparatus can be reduced.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

In addition, the computer-readable recording medium may be provided in the form of a non-transitory storage medium. Herein, the ‘non-transitory storage medium’ simply means that it is a tangible device and does not contain signals (e.g. electromagnetic waves), and this term does not distinguish between cases where data is semi-permanently stored in a storage medium and cases where data is stored temporarily. For example, the ‘non-transitory storage medium’ may include a buffer where data is temporarily stored.

According to an embodiment, methods according to various embodiments disclosed in this document may be provided and included in a computer program product. The computer program product is a commodity and may be traded between sellers and buyers. The computer program product may be distributed in the form of a machine-readable recording medium (e.g., compact disc read only memory (CD-ROM)), or may be distributed (e.g., downloaded or uploaded) online, through an application store (e.g., Play Store™) or directly between two user devices (e.g., smartphones). In the case of online distribution, at least a portion of the computer program product (e.g., a downloadable app) may be at least temporarily stored or created temporarily in the machine-readable recording medium, such as the memory of a manufacturer server, an application store server, or a relay server.

The embodiments disclosed with reference to the accompanying drawings have been described above. It will be understood by those skilled in the art that various changes in form and details may be made therein without departing from the spirit and scope of the disclosure as defined by the appended claims. The disclosed embodiments are illustrative and should not be construed as limiting.

What is claimed is:

1. An ultrasonic apparatus comprising:
an electrical component;
a housing configured to accommodate the electrical component and comprising openings provided to allow beat generated from the electrical component to be dissipated;
a grille formed integrally with the openings to partition the openings;
a filter configured to prevent foreign substances from being introduced into the housing through the openings; and
a fastening member configured to fix the filter to the housing,
wherein the grille comprises a hook configured to protrude toward the inside of the housing to guide a position of the filter.

2. The ultrasonic apparatus according to claim 1, wherein
the filter is disposed inside the housing.

3. The ultrasonic apparatus according to claim 1, wherein
a plurality of discharge holes is formed on the filter to allow air inside the housing to be discharged to the outside.

4. The ultrasonic apparatus according to claim 3, wherein
the filter comprises a first portion in which the discharge holes are formed and a second portion in which the discharge holes are not formed.

5. The ultrasonic apparatus according to claim 1, wherein
the hook is configured to penetrate the filter.

6. The ultrasonic apparatus according to claim 5, wherein
the filter comprises a coupling hole formed to be coupled with the hook.

7. The ultrasonic apparatus according to claim 6, wherein
the filter comprises a passing hole formed to allow the fastening member to pass therethrough.

8. The ultrasonic apparatus according to claim 7, wherein
the passing hole is formed in a central portion of the filter, and
the filter is formed in a symmetrical structure left and right about the central portion.

9. The ultrasonic apparatus according to claim 1, wherein
the housing comprises a curved portion formed as a curved surface, and
the openings are disposed in the curved portion.

10. The ultrasonic apparatus according to claim 9, wherein
the filter comprises a flexible material so as to cover inner sides of the openings.

11. The ultrasonic apparatus according to claim 10, wherein
a plurality of hooks is provided, and
the plurality of hooks is arranged to be spaced apart from each other.

12. The ultrasonic apparatus according to claim 11, wherein
the hook comprises a first hook disposed to be spaced apart from a center of the grille.

13. The ultrasonic apparatus according to claim 12, wherein
the hook comprises a second hook disposed to be closer to the center of the grille than the first hook.

14. The ultrasonic apparatus according to claim 1, wherein
the hook comprises a rib protruding upward or downward to prevent the filter from being separated.

15. A manufacturing method of an ultrasonic apparatus comprising:
forming a hook protruding toward the inside of a housing on a grille configured to partition openings provided to allow heat inside the housing to be dissipated to the outside;
forming a plurality of discharge holes on a filter configured to prevent foreign substances from being produced into the housing;
coupling the filter to the hook; and
fastening the filter to the housing.

16. The manufacturing method according to claim 15, wherein
a diameter of the discharge hole is 2 mm or more and 4 mm or less.

17. The manufacturing method according to claim 15, further comprising
forming a coupling hole on the filter to couple the filter to the hook.

18. The manufacturing method according to claim 17, wherein
the housing comprises a curved portion formed as a curved surface, and
the openings are disposed on the curved portion.

19. The manufacturing method according to claim 18, further comprising
manufacturing the filter comprising a flexible material so as to cover inner sides of the openings.

20. The manufacturing method according to claim 15, wherein
the hook comprises a first hook disposed to be spaced apart from a center of the grille, and a second hook disposed to be closer to the center of the grille than the first hook.
